(19) United States
(12) Patent Application Publication
(10) Pub. No.: US 2024/0083376 A1
(43) Pub. Date: Mar. 14, 2024

(54) BULKHEAD FITTING

(71) Applicant: Rivian IP Holdings, LLC, Plymouth, MI (US)

(72) Inventors: Casey Taylor Dunn, Mission Viejo, CA (US); Brandon Thayer, Mission Viejo, CA (US); Fwutsai Kuo, Laguna Woods, CA (US)

(21) Appl. No.: 18/193,090

(22) Filed: Mar. 30, 2023

Related U.S. Application Data
(60) Provisional application No. 63/375,424, filed on Sep. 13, 2022.

(51) Int. Cl. B60R 16/08; B60L 50/64

(52) U.S. Cl. CPC B60R 16/08; B60L 50/64

(57) ABSTRACT

The present disclosure relates to a system. The system can include a first fitting that can couple with a portion of a first fluid line. The first fluid line can be at least partially internal to a battery pack. The system can include a second fitting that can couple with a portion of a second fluid line. The second fluid line can be at least partially external to the battery pack. The first fitting can include a tab that can couple the first fitting with a portion of the battery pack. The first fitting can couple with the second fitting to fluidly couple the first fluid line with the second fluid line.

### CROSS-REFERENCE TO RELATED PATENT APPLICATIONS

This application claims the benefit of and priority to U.S. Provisional Patent Application No. 63/375,424, filed on Sep. 13, 2022, the entirety of which is incorporated by reference herein.

### INTRODUCTION

Vehicles can include fluid lines for thermal management of various vehicle components. For example, electric vehicles can include fluid lines to maintain thermal regulation of various components of a battery of the vehicle.

### SUMMARY

A serviceable fitting assembly of a vehicle, such as a bulkhead fitting assembly, can include a first fitting that can couple with a first coolant line that is at least partially inside a battery pack. The bulkhead fitting assembly can include a second fitting that can couple with a second coolant line that is at least partially outside of the battery pack. The first fitting can couple with the second fitting. The first fitting can include coupling means to couple with various portions of the battery pack. The second fitting can removably couple with the battery pack such that the second fitting can be replaced or removed from the battery pack during servicing. By having a modular fitting assembly, the second fitting can be removed from the battery pack without having to disassemble the battery pack. Thus, the fitting assembly can be serviced in a minimally invasive manner.

At least one aspect is directed to a system. The system can include a first fitting that can couple with a portion of a first fluid line. The first fluid line can be at least partially internal to a battery pack. The system can include a second fitting that can couple with a portion of a second fluid line. The second fluid line can be at least partially external to the battery pack. The first fitting can include a tab that can couple the first fitting with a portion of the battery pack. The first fitting can couple with the second fitting to fluidly couple the first fluid line with the second fluid line.

At least one aspect is directed to a battery pack. The battery pack can include a system. The system can include a first fitting that can couple with a portion of a first fluid line. The first fluid line can be at least partially internal to the battery pack. The fitting assembly can include a second fitting that can couple with a portion of a second fluid line. The second fluid line can be at least partially external to the battery pack. The first fitting can include a tab that can couple the first fitting with a portion of the battery pack. The first fitting can couple with the second fitting to fluidly couple the first fluid line with the second fluid line.

At least one aspect is directed to a method. The method can include providing a first fitting to couple with a portion of a first fluid line. The first fluid line can be at least partially internal to a battery pack. The method can include adjusting a tab of the first fitting to couple the first fitting with a portion of the battery pack. The method can include inserting a portion of a second fitting into a portion of the first fitting. The method can include coupling the second fitting with a portion of a second fluid line. The second fluid line can be at least partially external to the battery pack.

At least one aspect is directed to an electric vehicle. The electric vehicle can include a battery pack. The battery pack can include a first fitting that can couple with a portion of a first fluid line. The first fluid line can be at least partially internal to the battery pack. The battery pack can include a second fitting that can couple with a portion of a second fluid line. The second fluid line can be at least partially external to the battery pack. The first fitting can include a tab that can couple the first fitting with a portion of the battery pack. The first fitting can couple with the second fitting to fluidly couple the first fluid line with the second fluid line.

At least one aspect is directed to a system. The system can include a first fitting that can couple with a portion of a first fluid line. The first fluid line can be at least partially internal to a battery pack. The system can include a second fitting that can couple with a portion of a second fluid line. The second fluid line can be at least partially external to the battery pack. The first fitting can include coupling means that can couple the first fitting with a portion of the battery pack. The first fitting can couple with the second fitting to fluidly couple the first fluid line with the second fluid line.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with implementations.

FIG. 2A depicts an example battery pack, in accordance with implementations.

FIG. 2B depicts an example battery module, in accordance with implementations.

FIG. 3A depicts an example cross-sectional view of a portion of a system, in accordance with implementations.

FIG. 3B depicts an example cross-sectional view of a portion of a system, in accordance with implementations.

FIG. 4A depicts an example perspective view of a portion of the system of FIGS. 3A and 3B, in accordance with implementations.

FIG. 4B depicts an example perspective view of a portion of the system of FIGS. 3A and 3B, in accordance with implementations.

FIG. 4C depicts an example cross-sectional view of a portion of the system of FIGS. 3A and 3B, in accordance with implementations.

FIG. 5 depicts an example perspective view of the portion of the system of FIGS. 3A and 3B, in accordance with implementations.

FIG. 6 depicts an example illustration of a process of servicing a portion of a system, in accordance with implementations.

FIG. 7 depicts an example illustration of a process, in accordance with implementations.

### DETAILED DESCRIPTION

Following below are more detailed descriptions of various concepts related to, and implementations of, methods, apparatuses, and systems of a bulkhead fitting. The various concepts introduced above and discussed in greater detail below may be implemented in any of numerous ways.

This disclosure is generally directed to a bulkhead fitting assembly for a battery pack of an electric vehicle. The bulkhead fitting assembly can include an internal fitting to fluidly couple with a coolant line internal to the battery pack and an external fitting to fluidly couple with a coolant line external to the battery pack. The internal fitting can couple with the external fitting to fluidly couple the coolant lines. The internal fitting can include a retention tab having at least one step (e.g., protrusion) to couple with battery packs of various thicknesses. The bulkhead fitting assembly can include at least one compression gasket to seal the internal and external fittings with each other or with another portion of the battery pack. The external fitting can removably couple with the battery pack such that the external fitting can be replaced or removed from the battery pack as needed. The external fitting can include one or more radial seals that engage with the internal fitting to couple the fittings in a liquid-tight manner.

The disclosed solutions have at least one technical advantage of servicing the fitting assembly. By having a modular fitting assembly (e.g., having at least two fittings), at least one fitting can be removed or replaced from the battery pack without the need to remove another fitting. For example, the second fitting (e.g., the at least partially external fitting) can be removed or replaced from the first fitting (e.g., the at least partially internal fitting) while the first fitting is coupled with a portion of the battery pack. This can reduce or eliminate the need to take apart the battery pack to remove or replace a portion of the fitting assembly (e.g., if a fitting is damaged). Thus, the technical solution provides apparatus, systems, and methods for servicing a fitting assembly in a minimally invasive manner. Further, the retention tabs of the first fitting can allow for the fitting assembly to accommodate and couple to a battery pack, or other surface, of various thicknesses. This can reduce time required for manufacturing.

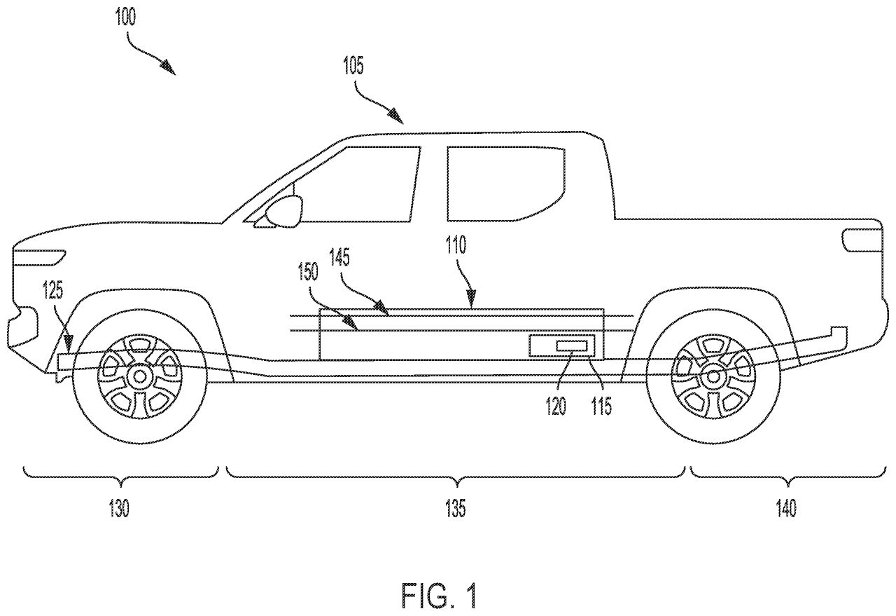

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115, possibly battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, battery modules 115, or the battery cells 120 with other electrical components of the electric vehicle 105 to provide electrical power to various systems or components of the electric vehicle 105.

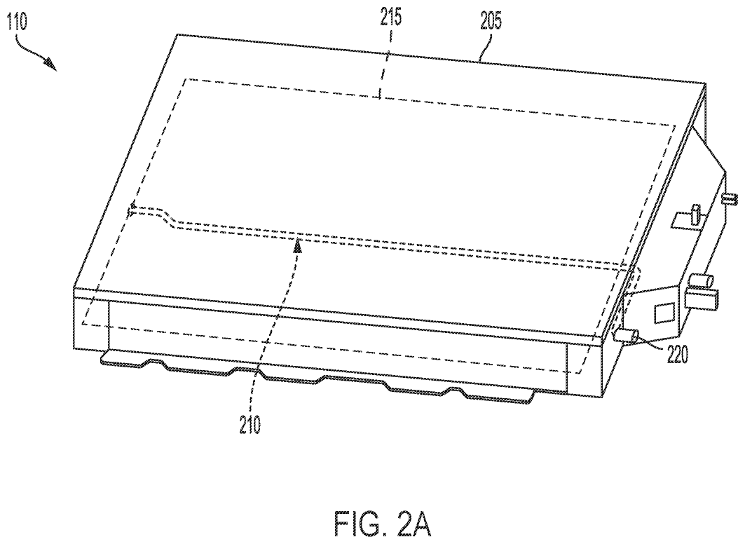

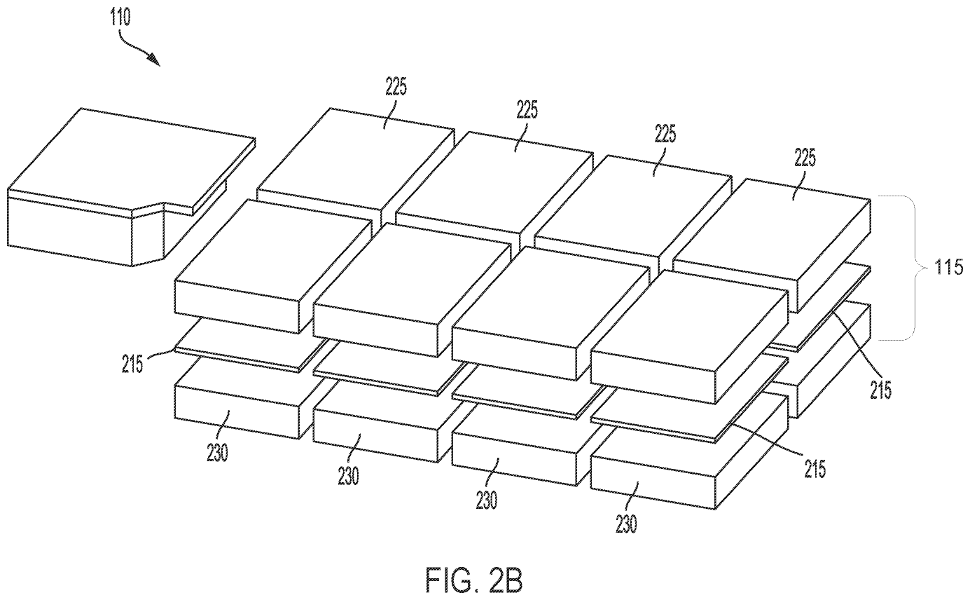

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack 110 components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115. The battery modules 115 can include at least one submodule. For example, the battery modules 115 can include at least one first (e.g., top) submodule 225 or at least one second (e.g., bottom) submodule 230. At least one thermal component 215 can be disposed between the top submodule 225 and the bottom submodule 230. For example, one thermal component 215 can be configured for heat exchange with one battery module 115. The thermal component 215 can be disposed or thermally coupled between the top submodule 225 and the bottom submodule 230. One thermal component 215 can also be thermally coupled with more than one battery module 115 (or more than two submodules 225, 230). The thermal components 215 shown adjacent to each other can be combined into a single thermal component 215 that spans the size of one or more submodules 225 or 230. The thermal component 215 can be positioned underneath submodule 225 and over submodule 230, in between submodules 225 and 230, on one or more sides of submodules 225/230, among other possibilities. The thermal component 215 can be disposed in sidewalls, cross members, structural beams, among various other components of the battery pack, such as battery pack 110 described above. The battery submodules 225, 230 can collectively form one battery module 115. In some examples each submodule 225, 230 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 225 and a bottom submodule 230, possibly with a thermal component 215 in between the top submodule 225 and the bottom submodule 230. The battery pack 110 can include or define a plurality of areas for positioning of the battery module 115 or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 may be inserted in the battery pack 110 without battery modules 225 and 230. The battery cells 120 may be disposed in the battery pack 110 in a cell-to-pack configuration without modules 225 and 230, among other possibilities.

Battery cells 120 have a variety of form factors, shapes, or sizes. For example, battery cells 120 can have a cylindrical, rectangular, square, cubic, flat, pouch, elongated or prismatic form factor. Battery cells 120 can be assembled, for example, by inserting a winded or stacked electrode roll (e.g., a jelly roll) including electrolyte material into at least one battery cell housing. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The battery cell 120 can include an electrolyte layer where the electrolyte layer can be or include solid electrolyte material that can conduct ions. For example, the solid electrolyte layer can conduct ions without receiving a separate liquid electrolyte material. Battery cells 120 can be assembled, for example, by inserting a winded or stacked electrode roll (e.g., a jelly roll) including electrolyte material into at least one battery cell housing. The electrolyte material, e.g., an ionically conductive fluid or other material, can support conduction of ions between electrodes to generate or provide electric power for the battery cell 120. The housing can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal (e.g., a positive or anode terminal) and a second polarity terminal (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing can be disposed in the battery module 115, the battery pack 110, or a battery array installed in the electric vehicle 105. The housing can be of any shape, such as cylindrical with a circular, elliptical, or ovular base, among others. The shape of the housing can also be prismatic with a polygonal base. The housing can include other form factors, such as a triangle, a square, a rectangle, a pentagon, and a hexagon, among others. It should be noted that the battery cells 120 can be inserted directly in the battery pack 110 without battery modules 115. For example, the battery pack may not include modules (e.g., module-free). For example, the battery pack can have a module-free or cell-to-pack configuration where the battery cells can be arranged directly into a battery pack without assembly into a module.

The housing of the battery cell 120 can include one or more materials with various electrical conductivity or thermal conductivity, or a combination thereof. The electrically conductive and thermally conductive material for the housing of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing of the battery cell 120 is prismatic or cylindrical, the housing can include a rigid or semi-rigid material such that the housing is rigid or semi-rigid (e.g., not easily deformed or manipulated into another shape or form factor). In examples where the housing includes a pouch form factor, the housing can include a flexible, malleable, or non-rigid material such that the housing can be bent, deformed, manipulated into another form factor or shape.

The battery cell 120 can include at least one anode layer, which can be disposed within the cavity defined by the housing. The anode layer can include a first redox potential. The anode layer can receive electrical current into the battery cell 120 and output electrons during the operation of the battery cell 120 (e.g., charging or discharging of the battery cell 120). The anode layer can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer (e.g., a composite cathode layer compound cathode layer, a compound cathode, a composite cathode, or a cathode). The cathode layer can include a second redox potential that can be different than the first redox potential of the anode layer. The cathode layer can be disposed within the cavity. The cathode layer can output electrical current out from the battery cell 120 and can receive electrons during the discharging of the battery cell 120. The cathode layer can also release lithium ions during the discharging of the battery cell 120. Conversely, the cathode layer can receive electrical current into the battery cell 120 and can output electrons during the charging of the battery cell 120. The cathode layer can receive lithium ions during the charging of the battery cell 120.

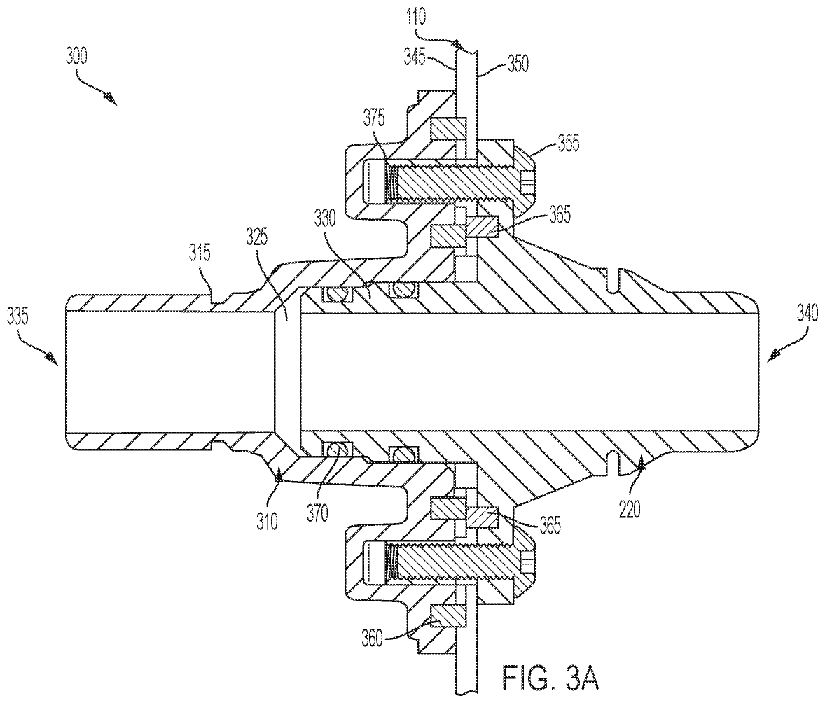

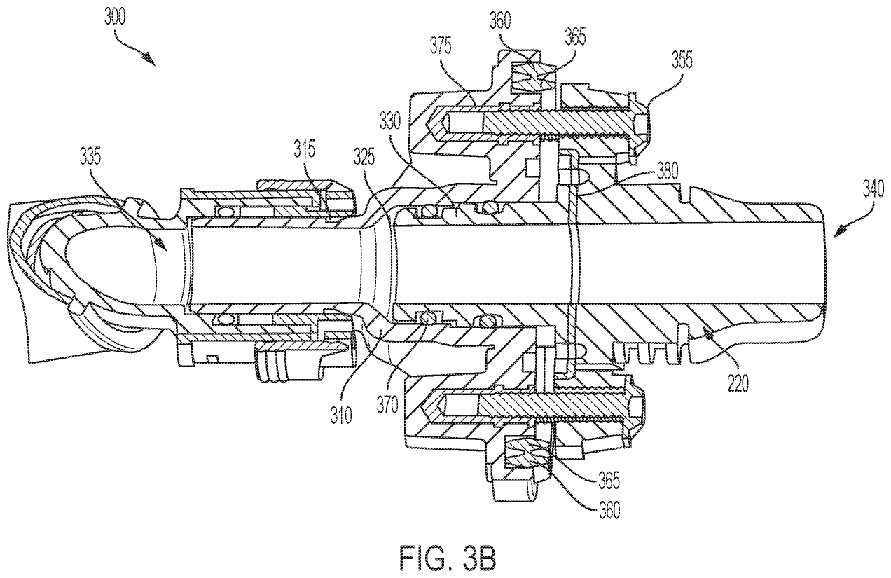

FIGS. 3A and 3B depict example cross-sectional views of a system 300 of the vehicle 105. For example, the system 300 (e.g., a battery pack system 300) can be or can include one or more devices or apparatuses (e.g., a fitting assembly) that facilitate coupling the at least one coolant line 210 (depicted in at least FIG. 2A, the coolant line 210 can couple with an end 335 of the first fitting 310 described herein) with one or more portions of the battery pack 110. The coolant line 210 can be or can include at least one coolant fluid. For example, the battery pack system 300 can include at least one coolant fluid that is circulated throughout the battery pack 110 to maintain thermal regulation of the battery cells 120 within the battery pack 110. Thermal regulation of the battery cells 120 can include maintaining each cell 120 or each module 115 within a specific temperature range (e.g., less than 60 degrees Celsius, greater than 0 degrees Celsius, or within another specific temperature range) or maintaining a temperature difference between one or more battery cells 120 or modules 115 within the battery pack 110 to a minimum (e.g., within 5%, within 10%, within 20%, within 50%, etc.). The coolant line 210 or another portion of the system 300 can include at least one radiator or evaporator to release or remove heat from the battery pack 110 (e.g., to release heat from the battery pack 110 to an area that is exterior to the battery pack 110). The coolant line 210 can include at least one air conditioning component to provide cooler temperatures within the cooling. For example, the coolant line 210 can include various types of glycols or polyglycols. The coolant line 210 can include various other types of fluids to facilitate thermoregulation of the battery cells 120.

The coolant line 210 can be or can include at least one physical line (e.g., a fluid conduit, pipe, channel, tube, or the like) to transfer, transmit, or receive a fluid. The fluid can be or can include any substance that is capable of flowing or easily changing shape (e.g., a liquid or gas). The fluid can be or can include any substance that is capable of thermally regulating one or more portions of the battery pack system 300. For example, the fluid can be or can include a solid, liquid, gas, or any combination thereof, that can facilitate maintaining thermal regulation of the battery pack system 300.

The coolant line 210 can include various pipes, tubes, conduits, connectors, or the like to transmit fluid throughout the battery pack 110 to one or more battery modules 115 or another component of the battery pack 110. For example, the coolant line 210 can include at least one pipe, tube, or conduit disposed at least partially within the battery pack 110 (e.g., within the housing 205 of the battery pack 110) to facilitate thermoregulation of the battery modules 115. The coolant line 210 can fluidly couple with at least one fitting (e.g., a first fitting 310). The coolant line 210 can fluidly couple to the first fitting 310 such that the coolant line 210 can receive or transmit fluid from a portion internal to (e.g., inside of) the battery pack 110 to a portion that is external to (e.g., outside of) the battery pack 110, or from an external portion to an internal portion.

The first fitting 310 can be or can include any fitting, connector, coupling, or the like to facilitate coupling the coolant line 210 with another component, such as a second fitting 220 or a second fluid line (e.g., a second pipe, tube, conduit, or set of pipes, tubes, or conduits to receive or transmit fluid to or from the first coolant line 210). The first fitting 310 can include a variety of shapes or sizes. For example, the first fitting 310 can have a generally cylindrical, spherical, or rectangular shape, or a variety of combinations of shapes. The first fitting 310 can include a shape to fit within or accommodate a portion of the battery pack 110. For example, the first fitting 310 can be manufactured (e.g., molded, extrusion, casting, or another technique) to fit within a portion of the battery pack 110 such that the battery pack 110 does not need to be adjusted to accommodate the first fitting 310.

The first fitting 310 can vary in size to couple with a portion of the first coolant line 210. The coolant line 210 can couple with the first fitting 310 in a variety of ways. For example, the first fitting 310 can include one or more protrusions or divots 315 that can at least partially receive the coolant line 210. For example, the coolant line 210 can include one or more projections to fit over (e.g., clip onto, lock onto) the divots 315 of the first fitting 310 (e.g., such that a portion of the coolant line 210 receives a portion of the first fitting 310). The coolant line 210 can fit within a portion of the first fitting 310 (e.g., such that the first fitting 310 receives a portion of the coolant line 210), as another example.

The battery pack system 300 can include one or more components to facilitate fixing the first coolant line 210 with the first fitting 310. For example, the system 300 can include pins, clamps, clips, compression fittings, fasteners, or other coupling elements. The coolant line 210 can include a variety of components to couple with the first fitting 310 such that fluid can flow from the coolant line 210 through the first fitting 310, or from the first fitting 310 through the coolant line 210. For example, the first fitting 310 can be at least partially hollow to receive or transmit the fluid.

The battery pack system 300 can include at least one second fitting 220 to couple with the first fitting 310. The second fitting 220 can be or can include any fitting, connector, coupling, or the like to facilitate coupling the coolant line 210 (e.g., via the first fitting 310) with another component, such as a second fluid line (e.g., a second pipe, tube, conduit, connectors, or set of pipes, tubes, conduits, or connectors to receive or transmit fluid to or from the first coolant line 210). The second fitting 220 can include a variety of shapes or sizes. For example, the second fitting 220 can have a generally cylindrical, spherical, or rectangular, shape, or a variety of combinations of shapes. The second fitting 220 can vary in size to couple with a portion of the first fitting 310. For example, the second fitting 220 can include at least one portion that can insert into a portion of the first fitting 310. For example, the first fitting 310 can include a first mating portion 325 that can receive a mating portion 330 (e.g., the second mating portion) of the second fitting 220. The first mating portion 325 can be or can include one or more portions of open space to at least partially receive the second mating portion 330 of the second fitting 220. The first mating portion 325 can alternatively or additionally include a protruding portion to be inserted into the second mating portion 330 of the second fitting 220.

The first fitting 310 and the second fitting 220 can be made of a variety of materials. For example, the first fitting 310 or the second fitting 220 can be made of various non-metallic materials, such as plastic (e.g., polycarbonate, nylon, or other material). The first fitting 310 or the second fitting 220 can be made of various metallic materials, such as aluminum, as another example. The first fitting 310 or the second fitting 220 can be made of a combination of various metallic and non-metallic materials, as yet another example. The first fitting 310 and the second fitting 220 can be made from the same materials. The first fitting 310 and the second fitting 220 can be made from different materials, as another example. The second fitting 220 can include at least one conductive portion 380 made from one or more conductive materials for providing an electrical conductive path.

The first fitting 310 and the second fitting 220 can include a variety of components to couple with the first coolant line 210 such that fluid can flow from the first coolant line 210 through the first fitting 310 and second fitting 220, or from the second fitting 220 through the first fitting 310 and the first coolant line 210. For example, the first fitting 310 and the second fitting 220 can be at least partially hollow to receive or transmit the fluid, as shown in at least FIGS. 3A and 3B.

At least a portion (e.g., a portion, a majority, or an entirety) of the first fitting 310 can be disposed on an interior side 345 of a battery pack 110. For example, the first fitting 310 can be at least partially or entirely disposed on the interior side 345 of a surface of the battery pack 110 such that at least a portion of the first fitting 310 does not protrude beyond the surface of the battery pack 110. The surface of the battery pack 110 can include a surface of the housing 205 of the battery pack 110. At least a portion (e.g., a portion, a majority, or an entirety) of the second fitting 220 can be disposed on an exterior side 350 of a battery pack 110. For example, the second fitting 220 can be at least partially or entirely disposed on the exterior side 350 of a surface of the battery pack 110 such that at least a portion of the second fitting 220 protrudes beyond the surface of the battery pack 110 (e.g., away from the exterior side 350 and away from the housing 205 of the battery pack 110).

The first coolant line 210 can be positioned at least partially interior to the battery pack 110 (e.g., adjacent the interior side 345 of the battery pack surface). For example, the first coolant line 210 can include at least one conduit, tube, fitting, connector, or the like that is positioned within a portion of the battery pack 110 (e.g., within the housing 205 of the battery pack 110 or adjacent one or more battery modules 115) such that fluid flowing through the first coolant line 210 can flow through an internal portion of the battery pack 110). The first coolant line 210 can be positioned entirely within the battery pack 110 (e.g., such that the first coolant line 210 is not exposed to an exterior of the battery pack 110 or such that the first coolant line 210 is entirely disposed within the housing 205), as another example.

The second fluid line (e.g., a second tube, conduit, channel, or the like that couples to an end portion 340 of the second fitting 220) can be positioned at least partially outside of the battery pack 110. For example, the second fluid line (represented as end 340) can include at least one conduit, tube, fitting, connector, or the like that is positioned at least partially outside of the battery pack 110 (e.g., adjacent the exterior side 350 of the surface of the battery pack 110) such that fluid flowing through the second fluid line can flow through a portion that is external to or outside of the battery pack 110. The second fluid line can be positioned entirely external to the battery pack 110 (e.g., such that no portion of the second fluid line is positioned or disposed within the housing 205 of the battery pack 110), as another example. The second fluid line can be positioned entirely inside the battery pack 110 (e.g., such that at least a portion of the second fluid line is positioned or disposed within the housing 205 of the battery pack 110), as yet another example.

The first fitting 310 can couple with the second fitting 220 such that fluid can flow from the first fitting 310 to the second fitting 220 (e.g., through the hollow portions of the fittings) or from the second fitting 220 to the first fitting 310. For example, the first fitting 310 can fluidly couple with the second fitting 220. The first fitting 310 can couple with the second fitting 220 such that fluid can flow from the first fluid line to the second fluid line or from the second fluid line to the first fluid line via the first fitting 310 and the second fitting 220.

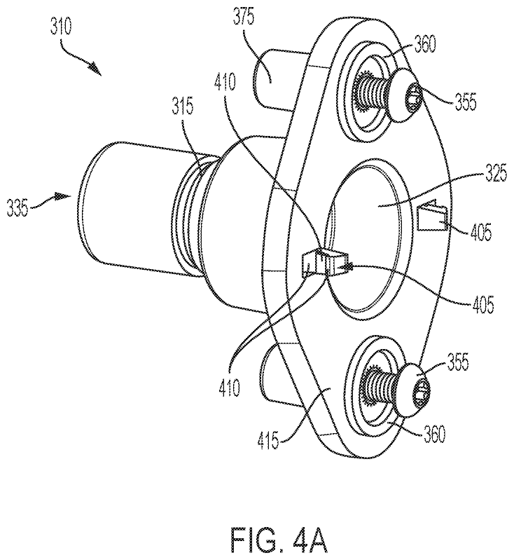

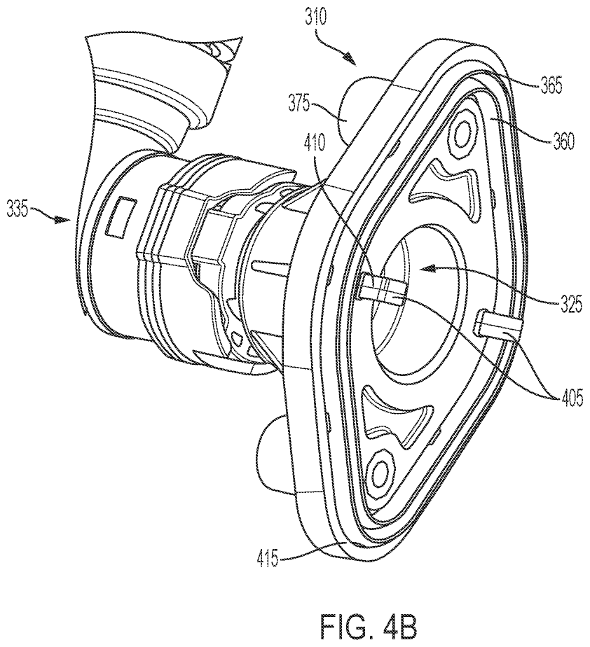

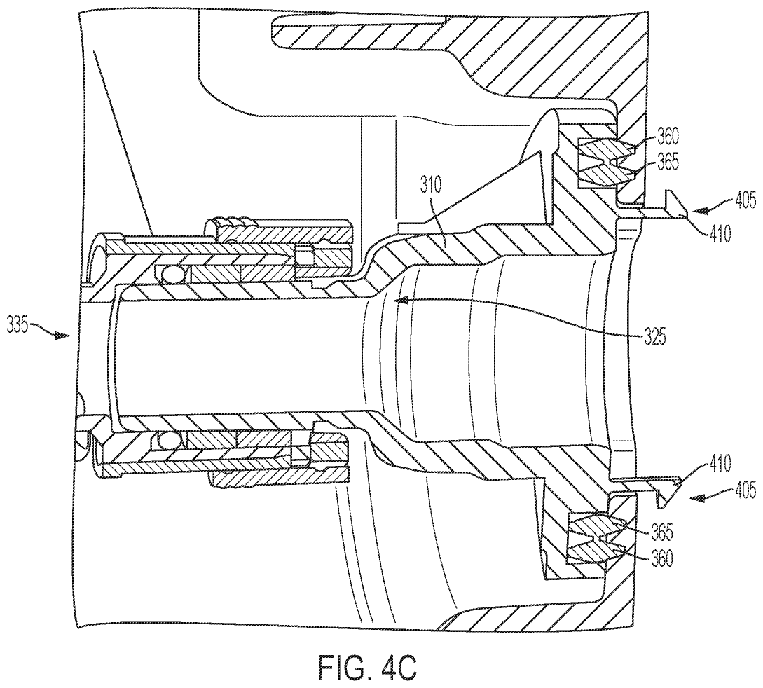

FIGS. 4A and 4B depict example perspective views of the first fitting 310 and FIG. 4C depicts a cross-sectional view of the first fitting 310. As depicted in at least FIGS. 3A, 3B, 4A, and 4B, the first fitting 310 or the second fitting 220 can couple with a portion of the battery pack 110 by at least one fastener 355. For example, the first fitting 310 can include at least one through hole 375 (e.g., pocket, protrusion, hole, extension, or other feature) to receive a fastener 355 (e.g., a screw, bolt, or other fastener).

The first fitting 310, or another portion of the system 300, can include at least one coupling means (e.g., a fastener, tab, clamp, protrusion, extension, rivet, projection, protrusion, anchor, toggle, or other type of coupling means) to couple with a surface of the battery pack 110 (e.g., with a portion of the housing 205). For example, the first fitting 310 can include at least one retention tab 405. For example, the first fitting 310 can include two retention tabs 405. The first fitting 310 can include more or less retention tabs 405 (e.g., one tab 405, three tabs 405, four tabs 405, or another amount of tabs 405). The retention tab 405 can be or can include a protrusion or extension that protrudes from a surface 415 of the first fitting 310 towards another portion of the system 300 (e.g., towards the second fitting 220 or towards the battery pack 110).

The retention tab 405 can include at least one step 410 to facilitate coupling with an external wall (e.g., a surface of the battery pack 110, a portion of the housing 205 of the battery pack 110 that runs adjacent to an exterior of the battery pack 110, a thickness between the interior side 345 and the exterior side 350) of the battery pack 110. For example, the step 410 can be or can include a flange, divot, protrusion, ledge, stair, ridge, projection, or other feature that can at least partially receive a portion of the battery pack 110 (e.g., a portion of a hole or bore of the battery pack 110 in which the second fitting 220 can couple). The steps 410 can be disposed at different lengths or portions of the retention tab 405 such that the retention tab 405 can couple with surfaces of varying thickness. For example, a first step 410 can protrude 0.5 mm from the surface 415 of the first fitting 310. The first step 410 can receive a portion of the battery pack 110 that includes a thickness of about 0.5 mm. A second step 410 can protrude 1 mm from the surface 415 of the first fitting 310. The second step 410 can receive a portion of the battery pack 110 that includes a thickness of about 1 mm. A third step 410 can protrude 3 mm from the surface 415 of the first fitting 310. The third step 410 can receive a portion of the battery pack 110 that includes a thickness of about 3 mm. These examples are for illustrative purposes. The steps 410 can be substantially smaller or larger. The retention tabs 405 can include multiple steps 410 that can ratchet and engage a multitude of mating surface material thicknesses. For example, the retention tab steps 410 can be designed to use compression of the compression gaskets described herein to engage and hold the first fitting 310 in place. For example, the steps 410 can protrude 0.001 mm. The steps 410 can protrude 10 mm or more. The steps 410 can be equal in size (e.g., each step is one size relative to another) or the steps 410 can each be different in size.

The one or more retention tabs 405 can include one step 410 to facilitate coupling with a portion of a battery pack 110. For example, as depicted in FIGS. 4B and 4C, the tabs 405 can include one or more steps 410. The steps 410 can protrude in a direction towards the first fitting 310 such that when the first fitting 310 is inserted into a battery pack 110 (e.g., in a direction from one end 335 towards the other end 340), the step 410 of the tab 405 can deform and snap back into position once passed through the battery pack 110 surface. The fasteners described herein can facilitate compressing the first fitting 310 such that a portion of the step 410 (e.g., the surface that extends parallel with a portion of the battery pack 110) can contact the battery pack 110.

The retention tabs 405 can adjust relative to the surface 415 (e.g., flex, bend, extend or retract from the surface 415 of the first fitting 310). For example, the tabs 405 can deflect transversely to flex inward to receive a portion of a wall of the battery pack 110 and can spring back out when the step 410 reaches a back of the wall of the battery pack 110. As another example, the retention tabs 405 can move in a linear direction to extend beyond the surface 415 or to retract towards the surface 415 to adjust relative to the battery pack 110 to facilitate coupling the tabs 405 with a portion of the battery pack 110.

The system 300 can include at least one compression gasket (e.g., seal, grommet, or another type of gasket). For example, the system 300 can include at least one first compression gasket 360 disposed around a portion of a fastener 355. For example, at least one first gasket 360 can be disposed between the through hole 375 that receives a fastener 355 and a head portion of the fastener 355. The second fitting 220 can be positioned adjacent to the first fitting 310 with the first compression gaskets 360 disposed around the through holes 375. The through holes 375 can receive the fasteners 355 with the second fitting 220 disposed adjacent to the first fitting 310 to couple the first fitting 310 and the second fitting 220. The surface 415 of the first fitting 310 can include one or more pockets (e.g., holes, openings, or other pockets) that can receive the first gasket 360 such that the first gasket 360 lies within a portion of the pocket. The first gasket 360 can abut a flat portion of the surface 415. The first gasket 360 can lie substantially flush with the surface 415 of the first fitting 310 or the first gasket 360 can protrude from the surface 415.

The system 300 can include at least one second compression gasket 365 (depicted in at least FIGS. 3A and 3B). The second gasket 365 can surround a portion of the second fitting 220. For example, the second gasket 365 can abut a surface of the second fitting 220 and can extend circumferentially around a bore of the second fitting 220 (e.g., around the second mating portion 330 in a circumferential direction). The second fitting 220 or the first fitting 310 can include one or more pockets (e.g., holes, openings, or other pockets) that can receive the second gasket 365 such that the second gasket 365 lies within a portion of the pocket. The second gasket 365 can abut a flat portion of the first fitting 310 or the second fitting 220. The second gasket 365 can lie substantially flush with a surface of the first fitting 310 or second fitting 210 or the second gasket 365 can protrude from the surfaces.

The first gasket 360 may extend entirely around a flat portion of the surface 415, as depicted in at least FIGS. 3B and 4B. The system 300 may or may not include the second gasket 365. For example, the first gasket 360 and the second gasket 365 may be monolithically connected to one another and disposed around a portion of the surface 415. In other words, the first gasket 360 and the second gasket 365 can form two sealing portions of a main gasket.

The system 300 can include at least one radial seal 370. For example, the radial seal 370 can be or can include an O-ring or another type of seal. The radial seal 370 can be disposed around a portion of the second fitting 220. For example, the second fitting 220 can include one or more radial seals 370 disposed circumferentially around the second mating portion 330 of the second fitting 220. The second fitting 220 can include two radial seals 370. Each radial seal 370 can be disposed about a different outer diameter portion of the second fitting 220, as depicted in at least FIGS. 3A and 3B.

The radial seals 370 can facilitate sealing the second fitting 220 with the first fitting 310. For example, the radial seals 370 can be disposed about an outer diameter (e.g., an outer wall or surface) of the second fitting 220 to engage with an inner diameter (e.g., an inner wall or surface) of the first fitting 310. The radial seals 370 can facilitate hermetically sealing the first fitting 310 with the second fitting 220 (e.g., in a liquid-tight manner).

The first or second radial seal 370 can provide an additional level of protection against fluid leaks between the first fitting 310, the second fitting 220, or a portion of the battery pack 110. For example, the radial seals 370 can vary in at least one of shape or size such that at least one radial seal 370 is at least partially redundant. For example, the system 300 may not include two radial seals 370 (e.g., only one radial seal 370). As another example, the system 300 can include more than one radial seal 370 (e.g., two seals 370, three seals 370, or more).

The radial seals 370 or the compression gaskets 360, 365 can be made of a variety of metallic or non-metallic materials, such as rubber or metal. The radial seals 370 can be the same (e.g., in size or shape) or they can at least partially differ from one another. For example, one radial seal 370 can be larger in diameter than another radial seal. The compression gaskets 360, 365 can be the same (e.g., in size or shape) or they can at least partially differ from one another. For example, the second compression gasket 365 can be larger in diameter than the first compression gasket 360.

The first gaskets 360, the second gasket 365, or the radial seals 370 can facilitate sealing the first fitting 310 with the second fitting 220 and the first fitting 310 and the second fitting 220 with the battery pack 110 (e.g., from an external environment) such that fluid can flow inside and outside of the battery pack 110 via the first fitting 310 and the second fitting 220 without the fluid being exposed to an external environment (e.g., outside of the battery pack 110, outside of the first fitting 310 or the second fitting 220). The fasteners 355 or the retention tabs 405 can facilitate compressing the gaskets 360, 365 such that the gaskets facilitate sealing the first fitting 310 with the second fitting 220.

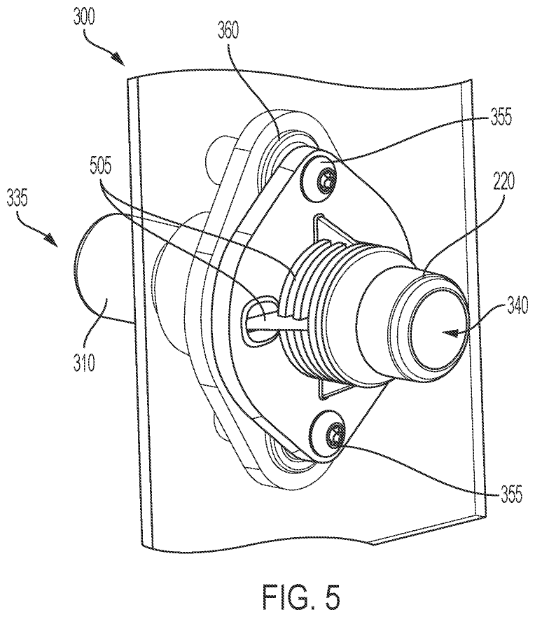

FIG. 5 depicts the second fitting 220 coupled with the first fitting 310 and a portion of the battery pack 110. The battery pack 110 is depicted as a straight, flat sheet of material for illustrative purposes. The battery pack 110 can include various shapes or configurations. As depicted in at least FIG. 5, fasteners 355 can couple the first fitting 310 with the second fitting 220. For example, the first fitting 310 can couple with the battery pack 110 and the tabs 405 can be adjusted to couple with a wall of the battery pack 110. The second fitting 220 can couple with the first fitting 310 by aligning the fasteners 355. At least one first gasket 360 can be disposed (e.g., sandwiched) between the first fitting 310 and the second fitting 220 or the battery pack 110.

The second fitting 220 can include at least one rib 505 to facilitate structurally supporting the second fitting 220. For example, the ribs 505 can extend in various directions relative to the hollow portion of the second fitting 220 to facilitate preventing flexion, bending, or other deformation of the second fitting 220 that could interfere with the liquid-tight seal of the second fitting 220 with the first fitting 310. For example, the ribs 505 can extend in a substantially axial direction relative to the first fitting 310 or the second fitting 220. The ribs 505 can extend circumferentially around the second fitting 220, as another example.

As described herein, the first fitting 310 can fit within a portion of the battery pack 110. For example, the battery pack 110 can be formed (e.g., casted or stamped) to include a bore to receive a portion of the first fitting 310. The first fitting 310 can be formed to fit within the bore of the battery pack 110 such that the geometry of the battery pack 110 does not need to be adjusted in order to receive the first fitting 310. The first fitting 310 or the second fitting 220 can be formed via injection molding or various other processes (e.g., thermoforming, blow molding, or another technique).

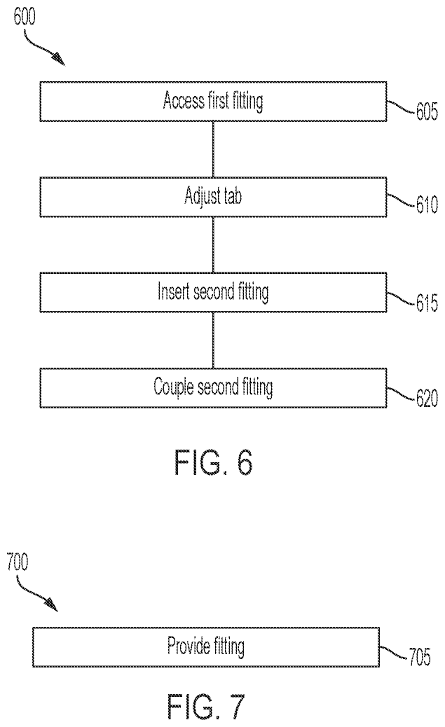

FIG. 6 depicts an example illustration of a method 600 of servicing a portion of the system 300. The method 600 can include providing the first fitting 310, as depicted in act 605. For example, the first fitting 310 can couple with a portion of a first fluid line 210. The first fluid line 210 can be located at least partially internal (e.g., within, enclosed by) to the battery pack 110, as depicted in at least FIG. 2A. Providing the first fitting 310 can include coupling the first fitting 310 with the first coolant line 210 that is at least partially internal to the battery pack 110. Providing the first fitting 310 can include viewing or accessing the first fitting 310, coupling the first fitting 310 with one or more portions of the battery pack system 300 (such as with the first coolant line 210 or with a the bore of the battery pack 110) inspecting the first fitting 310, removing the first fitting 310 from the battery pack 110, or replacing the first fitting 310.

The method 600 can include adjusting at least one tab 405 of the first fitting 310 to couple the first fitting 310 with a portion of the battery pack 110, as depicted in act 610. For example, the tab 405 (e.g., the retention tab) can include at least one step 410 to facilitate adjustably coupling with a wall (e.g., a thickness between the interior side 345 and the exterior side 350) of the battery pack 110. For example, the step 410 can be or can include a flange, divot, protrusion, ledge, stair, ridge, projection, or other feature that can at least partially receive a portion of the battery pack 110 (e.g., a hole or bore of the battery pack 110 in which the second fitting 220 can couple). The steps 410 can be disposed at different lengths or portions of the retention tab 405 such that the retention tab 405 can couple with surfaces of varying thickness. For example, a first step 410 can protrude 0.5 mm from the surface 415 of the first fitting 310. The first step 410 can receive a portion of the battery pack 110 that includes a thickness of about 0.5 mm. A second step 410 can protrude 1 mm from the surface 415 of the first fitting 310. The second step 410 can receive a portion of the battery pack 110 that includes a thickness of about 1 mm. A third step 410 can protrude 3 mm from the surface 415 of the first fitting 310. The third step 410 can receive a portion of the battery pack 110 that includes a thickness of about 3 mm. These examples are for illustrative purposes. The steps 410 can be substantially smaller or larger. The retention tabs 410 can adjust relative to the surface 415 (e.g., extend or retract from the surface 415 of the first fitting 310). For example, the retention tabs 410 can move in a linear direction to extend beyond the surface 415 or to retract towards the surface 415 to adjust relative to the battery pack 110.

The method 600 can include disposing at least one first gasket 360 around at least one through hole 375 that can receive a fastener 355. For example, the method 600 can include disposed two first gaskets 360 each around a through hole 375. The method 600 can include disposing at least one second gasket 365 around at least one bore of the first fitting 310 that can receive the second fitting 220 (e.g., such that the second fitting 220 can at least partially penetrate through an opening defined by the second gasket 365).

The method 600 can include inserting a portion of the second fitting 220 into a portion of the first fitting 310, as depicted in act 615. For example, the second mating portion 330 of the second fitting 220 can insert into the first mating portion 325 of the first fitting 310. The method 600 can include compressing the first gasket 360 or the second gasket 365 by the retention tabs 405. For example, coupling the battery pack 110 with a portion of the retention tab 405 can facilitate pulling the battery pack 110 towards the first fitting 310 to compress the gaskets. The method 600 can include fastening a portion of the second fitting 220 with a portion of the battery pack 110 or a portion of the first fitting 310. For example, the second fitting 220 can fasten to the battery pack 110 or the first fitting 310 through one or more fasteners 355. The fasteners 355 can facilitate compressing the first gasket 360 or the second gasket 365.

The method 600 can include coupling the second fitting 220 with a portion of a second fluid line, as depicted in act 620. For example, the second fitting 220 can couple with the second coolant line such that at least one of the second coolant line or the second fitting 220 is at least partially external to the battery pack housing 205. The second fitting 220 can couple with the second fluid line such that the first fluid line 210 can fluidly couple with the second fluid line by the first fitting 310 and the second fitting 220. For example, the second fitting 220 can couple with the second fluid line such that fluid can flow from inside the battery pack 110 to outside of the battery pack 110 by the hollow portions of the first fitting 310 and the second fitting 220.

The method 600 can include removing, replacing, accessing, or adjusting the second fitting 220. For example, the second fitting 220 can be removed (e.g., by hand or by one or more tools) from the second fitting 220 or from a portion of the battery pack 110. The second fitting 220 can be replaced and coupled with the first fitting 310 without having to take apart the battery pack 110 or the first fitting 310. For example, the second fitting 220 can be serviced (e.g., removed, replaced, accessed) while the first fitting 310 remains coupled with the first fluid line 210 and coupled with the battery pack 110 (e.g., with an external wall, such as a portion of the housing 205 of the battery pack 110). The second fitting 220 can be removed from the first fitting 310 by removing the fasteners 355. A new second fitting 220 can couple with the first fitting 310 by installing new fasteners 355 or using the previous fasteners 355 to couple a new second fitting 220.

FIG. 7 depicts an example illustration of a method 700. The method 700 can include providing a system 300, as depicted in act 705. The system 300 can include the first fitting 310 and the second fitting 220. The first fitting 310 can couple with the first fluid line 210 that is at least partially internal to the battery pack 110. The second fitting 220 can couple with the second fluid line that is at least partially external to the battery pack 110. The first fitting 310 can include at least one retention tab 405 to couple with surfaces (e.g., of various thicknesses). The system 300 can include at least one compression gasket (e.g., the first gasket 360 or the second gasket 365) or at least one radial seal 370 to facilitate sealing the first fitting 310 with the second fitting 220 and both the first fitting 310 and the second fitting 220 with the battery pack 110. The first fitting 310 can couple with the second fitting 220 by one or more fasteners 355.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, the second fitting 220 can include one or more retention tabs 405. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a first fitting to couple with a portion of a first fluid line, the first fluid line at least partially internal to a battery pack;
a second fitting to couple with a portion of a second fluid line, the second fluid line at least partially external to the battery pack;
the first fitting comprising a tab to couple the first fitting with a portion of the battery pack; and
the first fitting to couple with the second fitting to fluidly couple the first fluid line with the second fluid line.

2. The system of claim 1, comprising:
the second fitting configured to couple with the battery pack and the first fitting by a fastener; and
a compression gasket disposed around the fastener between the second fitting and the first fitting, the compression gasket configured to seal the first fitting with the second fitting.

3. The system of claim 1, comprising:
the tab configured to adjustably couple with an external wall of the battery pack.

4. The system of claim 1, comprising:
the second fitting having a compression gasket to seal the tab from an external environment.

5. The system of claim 1, comprising:
a first radial seal coupled with the second fitting and a second radial seal coupled with the second fitting; and
the first radial seal and the second radial seal configured to seal an external wall of the second fitting with an internal wall of the first fitting.

6. The system of claim 1, comprising:
a plurality of ribs disposed on the second fitting; and
the plurality of ribs to prevent flexion of the second fitting.

7. The system of claim 1, comprising:
the tab includes a first step and a second step; and
the second step extends beyond the first step.

8. A battery pack, comprising:
a system, the system including:
a first fitting to couple with a portion of a first fluid line, the first fluid line at least partially internal to the battery pack;
a second fitting to couple with a portion of a second fluid line, the second fluid line at least partially external to the battery pack;
the first fitting having a tab to couple the first fitting with a portion of the battery pack; and
the first fitting to couple with the second fitting to fluidly couple the first fluid line with the second fluid line.

9. The battery pack of claim 8, comprising:
the second fitting configured to couple with the battery pack and the first fitting by a fastener; and
a compression gasket disposed around the fastener between the second fitting and the first fitting, the compression gasket configured to seal the first fitting with the second fitting.

10. The battery pack of claim 8, comprising:
the tab configured to adjustably couple with an external wall of the battery pack.

11. The battery pack of claim 8, comprising:
the second fitting having a compression gasket to seal the tab from an external environment.

12. The battery pack of claim 8, comprising:
a first radial seal coupled with the second fitting and a second radial seal coupled with the second fitting; and
the first radial seal and the second radial seal configured to seal an external wall of the second fitting with an internal wall of the first fitting.

13. The battery pack of claim 8, comprising:
a plurality of ribs disposed on the second fitting; and
the plurality of ribs to prevent flexion of the second fitting.

14. The battery pack of claim 8, comprising:
the tab includes a first step and a second step; and
the second step extends beyond the first step.

15. A method of servicing a system, comprising:
providing a first fitting configured to couple with a portion of a first fluid line, the first fluid line at least partially internal to a battery pack;
adjusting a tab of the first fitting to couple the first fitting with a portion of the battery pack;
inserting a portion of a second fitting into a portion of the first fitting; and
coupling the second fitting with a portion of a second fluid line, the second fluid line at least partially external to the battery pack.

16. The method of claim 15, comprising:
the second fitting configured to couple with the battery pack and the first fitting by a fastener; and
a compression gasket disposed around the fastener between the second fitting and the first fitting, the compression gasket configured to seal the first fitting with the second fitting.

17. The method of claim 15, comprising:
the tab configured to adjustably couple with an external wall of the battery pack.

18. The method of claim 15, comprising:
the second fitting having a compression gasket to seal the tab from an external environment.

19. The method of claim 15, comprising:
a first radial seal coupled with the second fitting and a second radial seal coupled with the second fitting; and
the first radial seal and the second radial seal configured to seal an external wall of the second fitting with an internal wall of the first fitting.

20. The method of claim 15, comprising:
removing the second fitting from the first fitting to disconnect the second fluid line from the first fluid line; and
wherein the first fitting remains coupled with the first fluid line.
